(19) United States
(12) Patent Application Publication
(10) Pub. No.: US 2012/0038946 A1
(43) Pub. Date: Feb. 16, 2012

(54) INFORMATION PROCESSING APPARATUS, INFORMATION PROCESSING METHOD AND COMPUTER-READABLE MEDIUM

(75) Inventor: Takashi MONMA, Kanagawa (JP)

(73) Assignee: FUJI XEROX CO., LTD., Tokyo (JP)

(21) Appl. No.: 13/024,345

(22) Filed: Feb. 10, 2011

(30) Foreign Application Priority Data
Aug. 16, 2010 (JP) 2010-181607

(51) Int. Cl. G06F 3/12

(52) U.S. Cl. 358/1.15

(57) ABSTRACT

With respect to position candidates E and D where an image forming apparatus A is arranged, movement distances of the respective users in the position candidate E and the position candidate D are experimentally calculated based on use results of the users B and C. The side having a smaller sum value is calculated as the position candidate that can minimize the burden of necessary movement for all the users.

### CROSS-REFERENCE TO RELATED APPLICATION

This application is based on and claims priority under 35 USC 119 from Japanese Patent Application No. 2010-181607 filed on Aug. 16, 2010.

### BACKGROUND

### Technical Field

The present invention relates to an information processing apparatus, an information processing method and a computer-readable medium.

### SUMMARY

[1] According to an aspect of the invention, an information processing apparatus includes a position information storage unit, a use record acquisition unit, a movement distance calculation unit and a display control unit. The position information storage unit stores (i) installation position candidate information which is information on position candidates where at least one business machine is installed and (ii) user position candidate information which is information on position candidates of a plurality of users. The use record acquisition unit acquires use records in which the business machine is used by the plurality of users. The movement distance calculation unit calculates total sum of movement distances which are required when the plurality of users use the business machine in each combination of the installation position candidate information and the user position candidate information, based on the installation position candidate information and the user position candidate information stored in the position information storage unit and the use records acquired by the use record acquisition unit. The display control unit performs a control for displaying at least one side of a position of the business machine and positions of the plurality of users, in which the total sum of the movement distances is minimized, based on comparison of results calculated by the movement distance calculation unit.

### BRIEF DESCRIPTION OF THE DRAWINGS

Exemplary embodiments of the invention will be described in detail based on the following figures, wherein:

FIG. 1 is a block diagram illustrating an example of a system using the present invention;

FIG. 2 is a conceptual diagram illustrating a method for determining the positions of image forming apparatuses according to an embodiment of the invention;

FIG. 3 is a flowchart illustrating a processing procedure according to an embodiment of the invention;

FIG. 4 is a conceptual diagram illustrating a method for determining the positions of image forming apparatuses according to an embodiment of the invention;

FIG. 5 is a conceptual diagram illustrating a method for determining the positions of image forming apparatuses according to an embodiment of the invention;

FIG. 6 is a flowchart illustrating a processing procedure according to an embodiment of the invention; and

FIG. 7 is a flowchart illustrating a processing procedure according to an embodiment of the invention.

### DETAILED DESCRIPTION

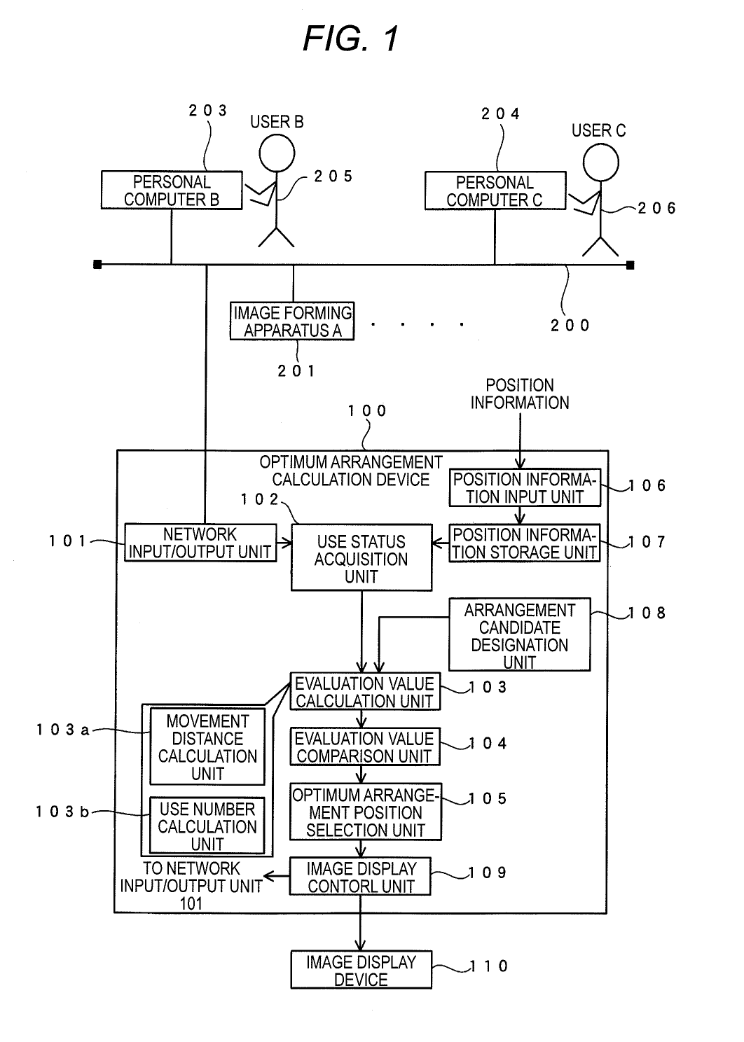

Hereinafter, an embodiment using the present invention will be described. FIG. 1 illustrates a system in which an optimum arrangement calculation apparatus 100, an image forming apparatus A 201, a personal computer B 203 operated by a user B, and a personal computer C 204 operated by a user C are connected through a communication unit. At least one of these functions is executed by a processor of the optimum arrangement calculation apparatus 100.

The optimum arrangement calculation apparatus 100 is an example of an information processing apparatus. The optimum arrangement calculation apparatus 100 is configured by software on a personal computer, and has the below functional units. That is, the optimum arrangement calculation apparatus 100 includes a network input/output unit 101, a use status acquisition unit 102, an evaluation value calculation unit 103, an evaluation value comparison unit 104, an optimum arrangement selection unit 105, a position information input unit 106, a position information storage unit 107, an arrangement candidate designation unit 108, and an image display control unit 109. The optimum arrangement calculation unit 100 is connected to an image display apparatus 110.

The network input/output unit 101 is an interface unit that is connected to a network line 200 such as LAN or the like, which is an example of a communication unit.

The use status acquisition unit 102 acquires use records of the image forming apparatus A 201, which is used by the personal computer B 203 operated by the user B 205 and the personal computer C 204 operated by the user C 206, from the image forming apparatus A 201 through the network line 200.

The use records are records (log data) related to the operation of the image forming apparatus A 201, and include information on an operation date, operation contents (for example, printing type, the number of prints, and the like), and users (user names). As the use records, records in a specified period, for example, for one month in the past, from installation up to the present, and the like, may be used.

The evaluation value calculation unit 103 calculates an evaluation value that becomes an index for determining whether the image forming apparatus A 201 exists in a position where a user can easily use the image forming apparatus A 201 based on information on the use records of the image forming apparatus A 291 that are acquired by the use status acquisition unit 102, position candidates where the image forming apparatus A 201 is installed, and position candidates of the user. In this example, as the evaluation value, a user's movement distance is adopted when the user uses the image forming apparatus.

Here, the position candidates where the image forming apparatus A 201 is installed and the user's position candidates also include information on fixed positions, that is, information on positions where the image forming apparatus or the user cannot move therefrom for some reason. The evaluation value calculation unit 103 includes a movement distance calculation unit 103a that calculates movement distances of the respective users and their sum when the users walk to the place of the image forming apparatus A 201 to access the image forming apparatus A 201. Also, the evaluation value calculation unit 103 includes a use number calculation unit 103b that calculates the number of times the image forming apparatus is used by the user.

The evaluation value comparison unit 104 compares evaluation values of plural arrangement patterns calculated by the evaluation value calculation unit 103. The optimum arrangement selection unit 105 calculates position information of an optimum arrangement of the image forming apparatus A 201 based on the result of comparison of the plural evaluation values in the evaluation value comparison unit 104. The information on the optimum arrangement of the image forming apparatus A 201 is output as optimum arrangement information.

The position information input unit 106 receives an input of the position information of the image forming apparatus and the user's position information before the arrangement is changed. In the case of FIG. 1, the position of the image forming apparatus A 201, the position of the user B 205 who operates the personal computer B 203, and the position of the user C 206 who operates the personal computer C 204 are input from the position information input unit 106.

The arrangement candidate designation unit 108 designates the candidate places where the image forming apparatus is arranged. Of course, the arrangement candidate designation unit 108 may designate the user's position candidates. Types of designation as described above may include a type in which a user designates the position candidate, a type in which a user designates one of plural enumerated candidates, and a type in which plural open spaces are selected on the side of the apparatus.

The image display control unit 109 performs a control for displaying an image that indicates the optimum arrangement of the image forming apparatus A 201 based on data of the optimum position of the image forming apparatus A 201 that is output from the optimum arrangement selection unit 105. The image display apparatus 110 is, for example, a liquid crystal display, and displays an image (image of a layout drawing) that indicates the optimum position of the image forming apparatus A 201 under the control of the image display control unit 109. On the other hand, the image display control unit 109 may send image data of an image that indicates the optimum position of the image forming apparatus A 201 to the image forming apparatus A 201 through the network input/output unit 101 to print out the corresponding image from the image forming apparatus A 201.

The image forming apparatus A 201 is an example of a business machine, and has a function of forming an image on a recording medium such as paper. In addition to the image forming, the image forming apparatus A 201 may also have a function of sorting or filing papers after the image forming. Here, although it is exemplified that one image forming apparatus is connected to the network line 200, it is also possible to connect plural image forming apparatuses to the network line 200 so that they can be used.

The personal computer B 203 is a personal computer that is operated by the user B 205, and the personal computer C 204 is a personal computer that is operated by the user C 206. In this example, the user B 205 operates the personal computer B 203 to make the image forming apparatus A 201 output (print) various kinds of documents, and the user C 206 operates the personal computer C 204 to make the image forming apparatus A 201 output (print) various kinds of documents as illustrated.

It is possible to configure the optimum arrangement calculation apparatus 100 by dedicated hardware. Also, the number of users may be two or more.

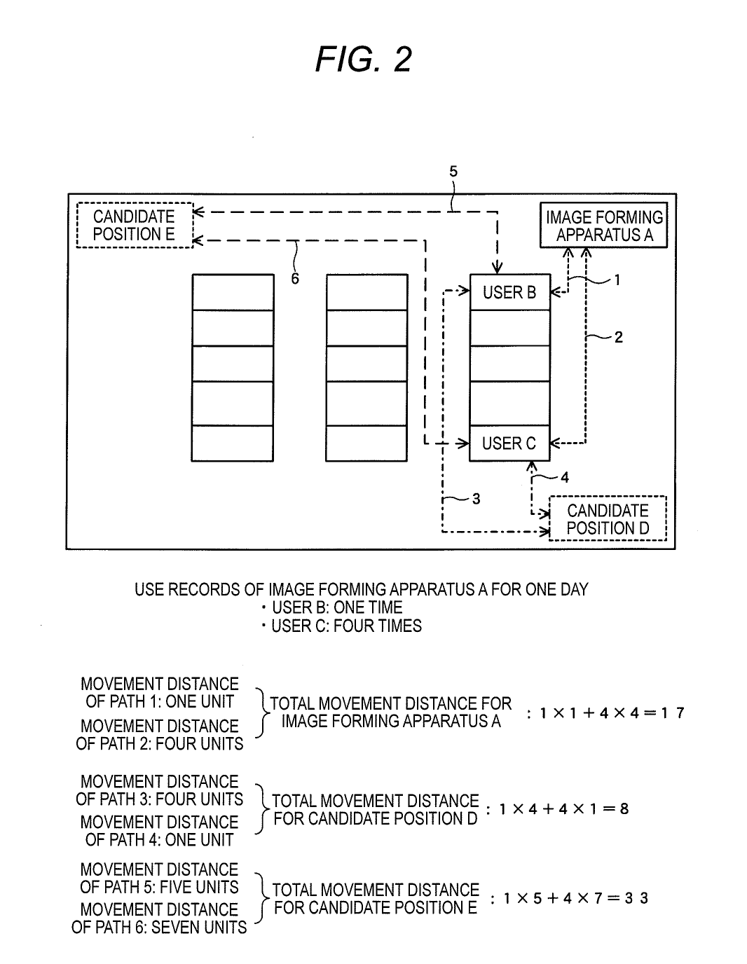

FIG. 2 conceptually illustrates a layout in an office. In FIG. 2, positions of an image forming apparatus A and seats of a user B and a user C who work there are indicated. In this example, a personal computer B is put on a desk of the user B, a personal computer C is put on a desk of the user C, and printing using the image forming apparatus A is performed by operating these terminals. In this example, an evaluation value for determining the optimum position of the image forming apparatus is calculated in consideration of users' movement distances as weight values. That is, with respect to position candidates E and D which are position candidates in which the image forming apparatus A is arranged, respective users' movement distances in the position candidate E and the position candidate D are experimentally calculated based on the use results of the image forming apparatus A by the users B and C up to that time, and the side having a smaller sum is estimated as a candidate where the image forming apparatus A is to be arranged. Accordingly, the position of the image forming apparatus A is estimated, which can minimize the burden of the necessary movement of the users B and C.

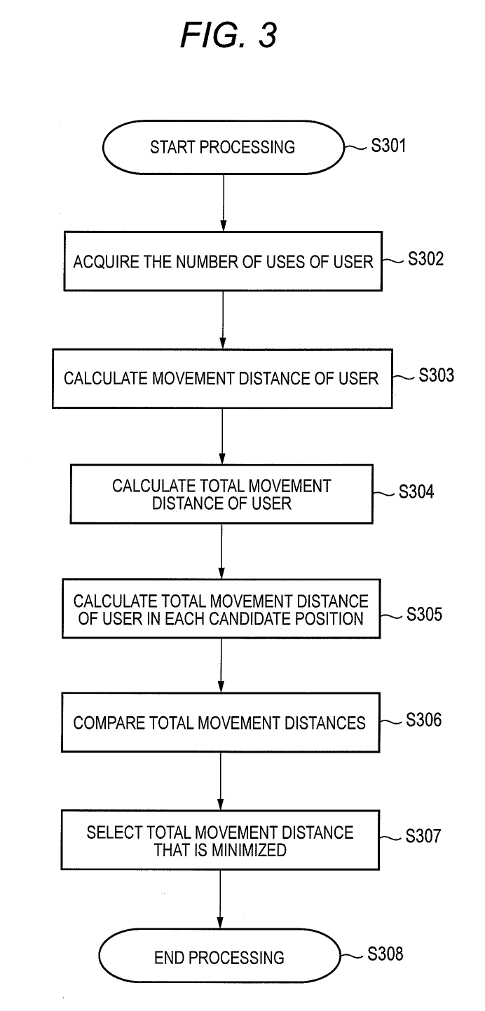

First, as a premise, it is assumed that information on a layout to be illustrated is acquired in advance, and a position candidate E and a position candidate D are designated in advance as candidates in which an image forming apparatus A is arranged. FIG. 3 illustrates an example of a processing procedure. A program that executes the processing in FIG. 3 is stored in an appropriate storage area inside an optimum arrangement calculation unit 100. This program may be stored in an appropriate storage medium and may be provided from the storage medium.

If the processing starts (step S301), the use records of the image forming apparatus A are first acquired, and the contents thereof are analyzed. Here, the number of times the respective users use the image forming apparatus A is acquired with reference to the use records for one day (step S302). In this example, the user B has the use results of one time, and the user C has the use results of four times.

Next, the movement distance (distance of a path indicated by a reference numeral “1” in FIG. 2) when the user B walks to the image forming apparatus A and the movement distance (distance of a path indicated by a reference numeral “2” in FIG. 2) when the user C walks to the image forming apparatus A are calculated (step S303). In this example, if it is assumed that the distance in which the user B moves to the image forming apparatus A (distance according to a route) is set to one unit, the distance in which the user C moves to the image forming apparatus A becomes four units. This information is calculated by the movement distance calculation unit 103a based on the position information stored in the position information storage unit 107 in FIG. 1.

Next, the total movement distance in the case where the user B and the user C use the image forming apparatus A is calculated (step S304). In this case, since the movement distance of the user B when the user B accesses the image forming apparatus A is one unit and the number of times the user B uses the image forming apparatus A is one time, the total movement distance of the user B becomes one unit. On the other hand, since the movement distance of the user C when the user accesses the image forming apparatus A is four units and the number of times the user C uses the image forming apparatus A is four times, the total movement distance of the user C becomes 16 units. Accordingly, the total movement distance becomes 17 (=1+16) units. The calculation of the total movement distance is performed by the movement distance calculation unit 103a.

Next, with respect to the designated position candidate D and position candidate E, the total movement distance is calculated on the condition of the same number of use times as the image forming apparatus A (step S305). In this case, it is assumed that the movement distances from the respective users to the respective image forming apparatuses are set as unit numbers as illustrated in FIG. 2. In this case, the total movement distance for the position candidate D becomes 8 units, and the total movement distance for the position candidate E becomes 33 units.

After step S305, the processing proceeds to step S306 to compare the total movement distances in the respective position candidates calculated in step S305. Based on the result of comparison, the candidate of which the total movement distance is minimized is selected (step S307). In this example, since the total movement distance of the position candidate D is minimized, the position candidate D is selected in the processing in step S307, and then the processing is ended (step S308).

In this case, in the arrangement candidates illustrated in FIG. 2, by arranging the image forming apparatus A on the position candidate D, the total movement distance in which two users walk to the image forming apparatus is minimized, and in consideration of all users, the burden of movement becomes smallest. This optimum position is displayed on the image forming apparatus 110 as a layout drawing.

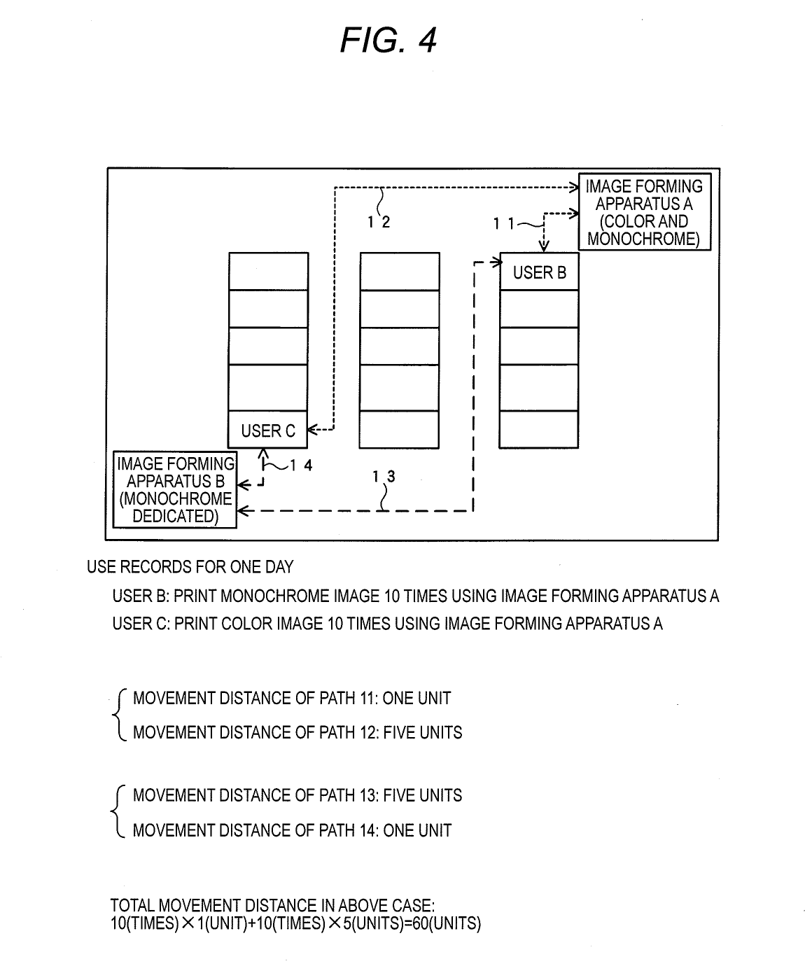

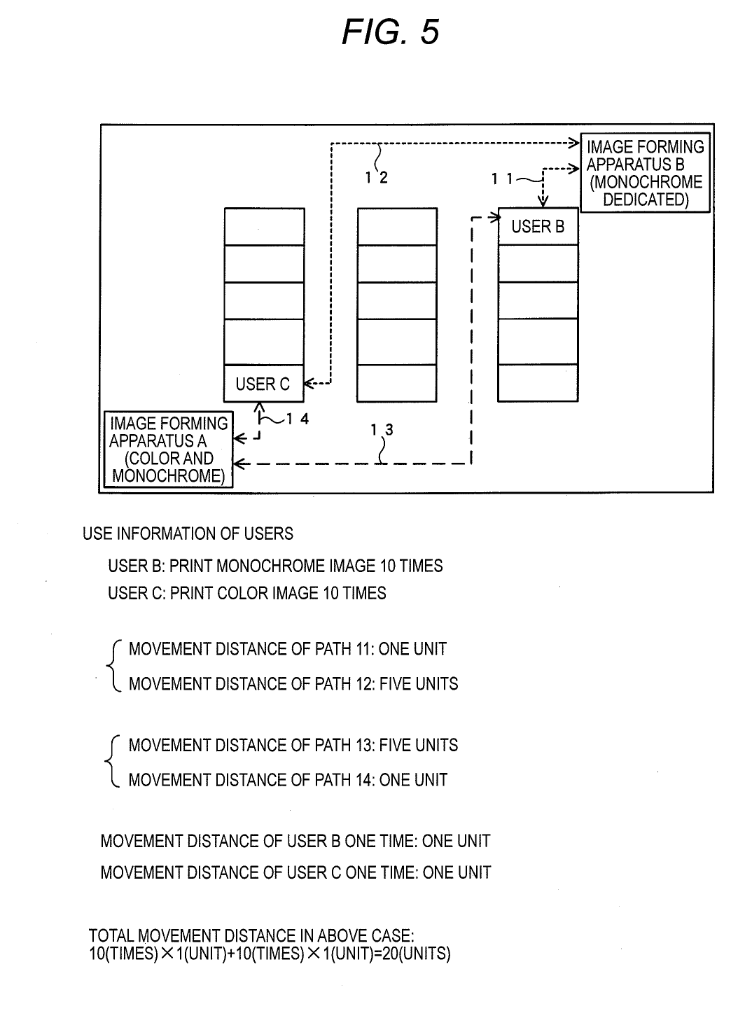

An example of a case where an operation is performed in consideration of the attribute of the task (for example, a difference between monochrome printing and color printing) will be described. FIG. 4 illustrates an image forming apparatus A that can perform both forming of a monochrome image and forming of a color image and an image forming apparatus B that can perform forming of a monochrome image only. First, in the layout illustrated in FIG. 4, it is assumed that a user B has the results of performing a monochrome image print 10 times using the image forming apparatus A, and a user C has the results of performing a color image print 10 times using the image forming apparatus A. In this case, in the layout illustrated in FIG. 4, the total movement distance of the user B and the user C becomes 60 units as illustrated in FIG. 4. Here, a case where the positions of the image forming apparatus A and the image forming apparatus B have been changed from each other will be considered. This case is illustrated in FIG. 5.

In this case, the results of the task contents are made to be related to the users, and based on this, the movement distances of the users are calculated. That is, the movement distances are calculated based on the use records in which the user B has performed the monochrome image printing 10 times and the user C has performed the color image printing 10 times.

In FIG. 5, since it is assumed that the user B prints the monochrome image, it is determined that the user B uses the nearest image forming apparatus B. Accordingly, the movement distance of the user B for each movement becomes one unit. Also, since it is assumed that the user C prints the color image, it is determined that the user C uses the image forming apparatus A, and the movement distance of the user C for each movement becomes one unit. Accordingly, if it is assumed that the same method as in the layout of FIG. 4 is used, the total movement distance of the two users becomes 20 units in the case of the layout of FIG. 5. Accordingly, comparing the case of FIG. 4 with the case of FIG. 5, the total movement distance becomes shorter in the case illustrated in FIG. 5, and thus on the assumption that two persons use the image forming apparatuses, it is concluded that the layout of FIG. 5 is more efficient arrangement of image forming apparatuses.

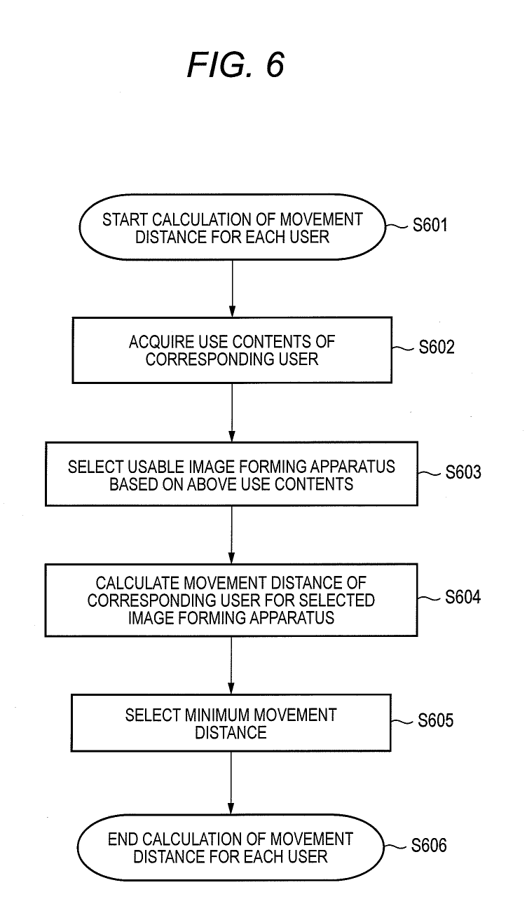

Hereinafter, an example of a detailed processing flow of calculating the movement distance for each user in the above-described example will be described. FIG. 6 illustrates an example of a detailed processing flow of calculating the movement distance for each user. Here, it is exemplified that the movement distance of the user B is calculated in the case of FIG. 5.

If the process starts (step S601), the use contents of the user B is acquired (step S602). In this case, the contents “monochrome image printing 10 times” as illustrated in FIG. 5 are acquired. Next, an image forming apparatus that can be used by the user B is selected (step S603). In this case, since there are an image forming apparatus A and an image forming apparatus B, and both image forming apparatuses can perform monochrome image printing, the image forming apparatus A and the image forming apparatus B are selected.

Then, the movement distance of the user B with respect to the selected image forming apparatuses is calculated (step S604). In this case, in the layout illustrated in FIG. 5, the movement distance 1 in which the user B performs a monochrome image printing using the image forming apparatus A and the movement distance 2 in which the user B performs a monochrome image printing using the image forming apparatus B are calculated. Here, since a path 13 is used for the movement distance 1, the movement distance 1 becomes 5 units. Also, since a path 11 is used for the movement distance 2, the movement distance 2 becomes one unit.

Also, the minimum movement distance is selected through comparison of the movement distance 1 with the movement distance 2 (step S605), and then the processing is ended (step S606). In this case, since the movement distance 2 is shorter, the movement distance 2, which becomes one unit, is selected. By doing this, in the case of the layout of FIG. 5, the movement distance of the user B for each movement becomes one unit.

Hereinafter, another example of a case where an operation is performed in consideration of the attribute of the task (for example, a difference between monochrome printing and color printing) will be described. Here, an example of a case where the arrangement of the image forming apparatuses is determined in consideration of the processing efficiency will be described on the assumption that the positions of the users who are candidates (the positions of seats) are fixed.

In this example, there are three image forming apparatuses as in Table 1 below. The respective image forming apparatuses have different combinations of functions as shown in Table 1. In Table 1, O indicates that an image forming apparatus has functions such as monochrome copy, color copy, stapler, and function as FAX or a printer. X indicates that an image forming apparatus does not have functions such as monochrome copy, color copy, stapler, and function as FAX or a printer.

TABLE 1

| | Copy | | | | |
|---|---|---|---|---|---|
| | Monochrome | Color | Stapler | FAX | Print |
| Image forming | ◯ | ◯ | ◯ | X | ◯ |
| apparatus A | | | | | |
| Image forming | ◯ | X | ◯ | ◯ | X |
| apparatus B | | | | | |
| Image forming | X | X | X | ◯ | ◯ |
| apparatus C | | | | | |

Table 2 shows an example of use information in this embodiment.

TABLE 2

| Processing | | | | |
|---|---|---|---|---|
| ID | User ID | Function | Date | Processing contents |
| 001 | User A | Copy | 2010/2/1/ | color, duplex, stapler |
| | | | 09:15 | 10 sheets |
| 002 | User B | FAX | 2010/2/1/ | FAX transmission, |
| | | | 09:40 | destination |
| | | | | xx-xxxx-xxxx |
| 003 | User C | Copy | 2010/2/01/ | monochrome, single side, |
| | | | 09:44 | 7 sheets |
| . . . | . . . | . . . | . . . | . . . |
| . . . | . . . | . . . | . . . | . . . |

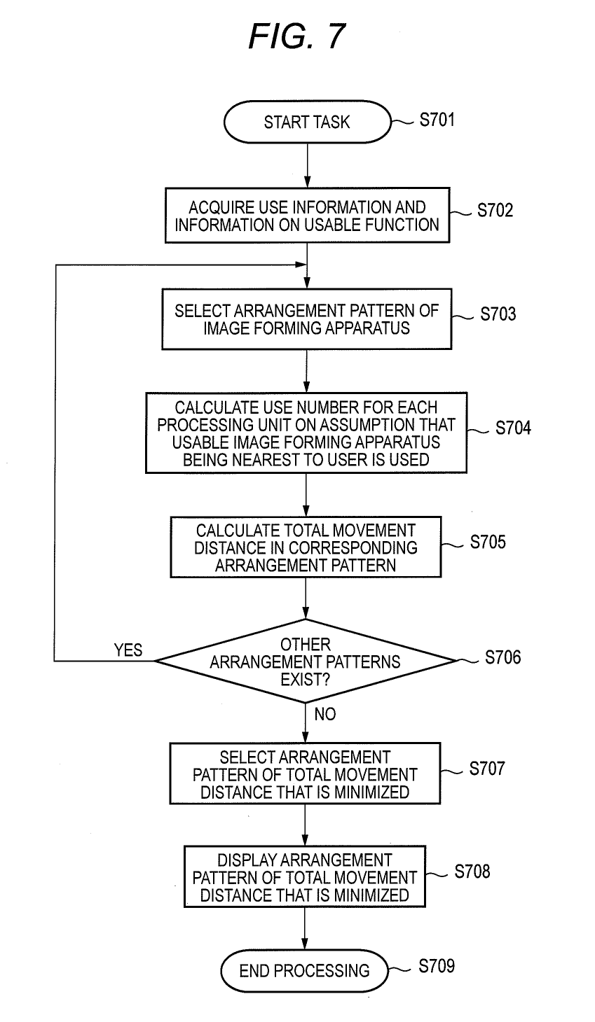

FIG. 7 illustrates an example of a processing flow according to this operational example. If the processing starts (step S701), use information as exemplified in Table 2 is first acquired (step S702). Then, one of arrangement patterns of plural image forming apparatuses is selected (step S702), and the number of use times as each image forming apparatus is calculated on the assumption that an image forming apparatus that is nearest to a corresponding user is used for each processing unit (step S704). An example of the results is shown in Table 3 below.

TABLE 3

| | User A | User B | User C |
|---|---|---|---|
| Image forming apparatus A | 10 times | 15 times | 10 times |
| Image forming apparatus B | 12 times | 11 times | 5 times |
| Image forming apparatus C | 1 time | 5 times | 0 times |

Also, the total movement distance of all users is calculated in the arrangement pattern selected in step S703 (step S705). Thereafter, it is determined whether other arrangement patterns that are not the subject of calculation of the total movement distance exist, and if other arrangement patterns exist, one of them is selected, and the process in steps S703 to the following is performed again. Also, if no other arrangement pattern exists, the processing proceeds to step S707, and the arrangement pattern having the minimum total movement distance is selected. Thereafter, the arrangement pattern of the image forming apparatus selected in step S707 is displayed on the image display apparatus (step S708), and the processing is ended (step S709).

In the operational examples 2 and 3 as described above, a process of adding the number of use times the usable image forming apparatus that is closest to the user who performs the corresponding process is used for each processing unit that is related to the respective users. Accordingly, even in the case where an image forming apparatus having plural functions is included in the image forming apparatuses to be used and the users use different functions of the image forming apparatuses, an optimum arrangement can be calculated.

For example, a case where the use of the image forming apparatus A illustrated in FIG. 2 becomes inconvenient or is displeased and a position where the task can be performed more efficiently is searched for is considered. In this case, by selecting plural positions where the image forming apparatus A can be put and performing an operation explained in relation to FIG. 2, the position of the image forming apparatus A can be calculated, in which more efficient task (task for which the total movement distance of the users becomes shorter), in which the actual task results of the user B and the user C are reflected, can be performed.

In this case, a test that actually moves the image forming apparatus A is not necessary, and more efficient installation place of the image forming apparatus A can be known by the operation with the detailed amount of movement of the operators as a variable.

In this case, instead of moving the image forming apparatus A, plural patterns of positions of users' seats are prepared, and the total amount of movement of the users in the respective patterns is calculated based on the task results of the respective movers. Then, by comparing the total amounts of movement of users in the respective patterns of the seat positions with one another, a pattern of seat positions which provides the minimum total amount of movement among the patterns is selected. Accordingly, the seat positions in which the task can be performed more efficiently can be determined.

In this case, by performing the same process, it is also possible to calculate an arrangement pattern of the seats and the image forming apparatuses, in which the task can be performed more efficiently, in the case of moving both the seat positions and the image forming apparatuses. In this case, plural patterns in which users' positions and the positions of the image forming apparatuses are changed are prepared, and a pattern in which the total movement distance is minimized is selected by the method of FIG. 2 or the method of FIG. 4 or 5, with respect to the respective patterns. In this case, the number of experimentally calculated patterns becomes larger, but the principle of operation is the same.

In an example illustrated in FIG. 2, it is also possible to extend the number of image forming apparatuses. The candidate positions in which the image forming apparatuses are arranged are not limited to corners of a room, but may be any positions where the image forming apparatuses can be put. In measuring the distances, straight distances may be adopted. It is also possible for a user to designate the route and to calculate the distance based on the designated route.

In addition to the distances, information on the amount of prints may be added. This is because, in the case where a large amount of prints exists, more labor is necessary in carrying the prints even if the movement distances are equal to one another. In this case, the calculated movement distance is multiplied by a coefficient according to the number of prints in order to make the information on the number of prints included in the movement distance. In this case, the movement distance calculation unit 103a of FIG. 1 has a function of multiplying the subject movement distance by the coefficient according to the number of prints.

It is also possible to calculate the movement distance to which ages or physical strengths are added by multiplying the calculated movement distance by a coefficient according to ages or physical strengths of the users. That is, in the case of a user of great physical strength, even if the movement distances are equal to each other, optimum positions of the image forming apparatuses to which factors of physical strength are added can be calculated by roughly making the coefficient small in comparison to a user of weak physical strength. In this case, the movement distance calculation unit 103a of FIG. 1 has a function of multiplying the subject movement distance by a relatively small coefficient in comparison to a user of weak physical strength, even if the movement distances are equal to each other, in the case of a user of great physical strength.

In setting a path, it is also possible to set the path to pass through a specified place (or not to pass through the specified place) in the case where it is desired to preferentially pass through the specified place (or it is desired not to pass through the specified place). In this case, the optimum arrangement position selection unit 105 of FIG. 1 is provided with a specified path setting unit (or a specified path avoiding unit) that sets to preferentially pass through the specified place (or not to pass through the specified place).

For example, in the case where two tasks that neighbor on a time axis is in a short time, such as within one minute, it is possible to count the number of uses, considering this as a task to be performed one time. In this case, the use number calculation unit 105b of FIG. 1 is provided with a function of considering plural tasks that are not continuous within a prescribed time as a task to be performed one time.

Even in the case where the total movement distance is minimized, it may be considered that any specified person experiences the increase of the movement distance. In this case, an emphasis indication may be made with respect to the user whose movement distance is increased to facilitate the recognition of the purport. Also, in a state where movement lines can be recognized by indicating movement paths as illustrated in FIGS. 2, 4, and 5, the results may be presented to the user. In this case, by indicating the movement paths by colors, it becomes easy to individually grasp the movement paths of the respective users. In this case, the image display control unit 109 of FIG. 1 is provided with an emphasis display control unit that performs an emphasis display with respect to the user whose movement distance is increased. Also, the image display control unit 109 of FIG. 1 is provided with a movement path emphasis display control unit that performs individual emphasis display with respect to the movement paths of the respective users.

In an example of performing an operation that has received the attribute of the task contents as explained using FIGS. 4 and 5, as attributes, a difference in image forming speed, a difference in usable paper, a difference in image quality, and existence/nonexistence of a function of sorting papers after the image forming may be used.

In the above-described examples, an image forming apparatus having an image forming function is exemplified as a business machine. However, as the subject business machine, a Schrader that operates by electronic control or mechanical control, a paper cutting device, a paper bending device, a stapler device, or a laminate device may be used.

The present invention may be used in a technology that determines the arrangement of business machines.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a position information storage unit that stores (i) installation position candidate information which is information on position candidates where at least one business machine is installed and (ii) user position candidate information which is information on position candidates of a plurality of users;
a use record acquisition unit that acquires use records in which the business machine is used by the plurality of users;
a movement distance calculation unit that calculates total sum of movement distances which are required when the plurality of users use the business machine in each combination of the installation position candidate information and the user position candidate information, based on the installation position candidate information and the user position candidate information stored in the position information storage unit and the use records acquired by the use record acquisition unit; and
a display control unit that performs a control for displaying at least one side of a position of the business machine and positions of the plurality of users, in which the total sum of the movement distances is minimized, based on comparison of results calculated by the movement distance calculation unit.

2. The information processing apparatus according to claim 1, wherein
a plurality of business machines having different functions exist as the business machine, and
the use record acquisition unit acquires information in which the plurality of users and functions included in the plurality of business machines which are used by the respective users are related to each other.

3. The information processing apparatus according to claim 2, wherein
in the case where a first business machine and a second business machine which are included in the plurality of business machines have a first common function, the movement distance calculation unit calculates based on a value on the side having a shorter movement distance that is required when the user who uses the first function uses the first common function.

4. An information processing method comprising:
storing (i) installation position candidate information which is information on position candidates where at least one business machine is installed and (ii) user position candidate information which is information on position candidates of a plurality of users;
acquiring use records in which the business machine is used by the plurality of users;
calculating the total sum of movement distances that are required when the plurality of users use the business machine in each combination of the installation position candidate information and the user position candidate information, based on the stored installation position candidate information and the stored user position candidate information and the acquired use records; and
controlling to display at least one side of a position of the business machine and positions of the plurality of users, in which the total sum of the movement distances is minimized, based on comparison of results calculated by the movement distance calculation unit.

5. A non-transitory computer-readable medium storing a program that causes a computer to execute information processing, the information processing comprising:
storing (i) installation position candidate information which is information on position candidates where at least one business machine is installed and (ii) user position candidate information which is information on position candidates of a plurality of users;
acquiring use records in which the business machine is used by the plurality of users;
calculating the total sum of movement distances that are required when the plurality of users use the business machine in each combination of the installation position candidate information and the user position candidate information, based on the stored installation position candidate information and the stored user position candidate information and the acquired use records; and
controlling to display at least one side of a position of the business machine and positions of the plurality of users, in which the total sum of the movement distances is minimized, based on comparison of results calculated by the movement distance calculation unit.
